(19) United States
(12) Patent Application Publication
(10) Pub. No.: US 2007/0226051 A1
(43) Pub. Date: Sep. 27, 2007

(54) Method and system for pay-per-transaction promotions and measurement of resulting ROI

(76) Inventors: Sateesh Kumar Addepalli, San Jose, CA (US); Atul D Shinde, Cupertino, CA (US); Sumit Gautam, Sunnyvale, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/306,010

(22) Filed: Dec. 14, 2005

(51) Int. Cl. G06Q 30/00

(52) U.S. Cl. 705/14

(57) ABSTRACT

A beginning to end method of distributing marketing promotions to consumers through mobile devices is disclosed. Sellers of goods or services set criteria for the selection of consumers eligible to receive coupons or other promotional material. Consumers who request product information are sent mobile messages that contain personalized promotions matched to the consumer's preferences and the seller's distribution criteria. The consumer's request, receipt, use, redemption, and settlement of promotional instruments is monitored and facilitated to allow rapid calculation of the seller's return on investment and payment for each completed transaction.

### BACKGROUND OF THE INVENTION

### Field of the Invention

The present invention is related to methods of distributing on-demand, customized marketing promotions that reflect a consumer's location and preferences and a seller's promotional policies.

### SUMMARY OF THE INVENTION

The disclosed invention provides means and methods to allow enterprise entities the ability to quickly distribute, in an automated fashion, marketing promotions and marketing campaigns that are customized to each consumer. The distribution and content of promotions are customized for each consumer based upon the location of the consumer, data collected from the consumer and/or enterprise policies. The disclosed invention provides a complete method for all steps (request, selection, distribution, redemption, and settlement) needed to implement a marketing promotion to mobile consumers and means for accurate measurement of return on investment. Enterprise entities may be charged on a pay-per-transaction basis in accordance with the disclosed invention.

A set of databases and servers track and facilitate a consumer's request, receipt, use, redemption, and settlement of promotions while tracking an enterprise's return on investment and charging a fee or commission to the enterprise for each transaction. An enterprise may quickly adjust their marketing campaign to fit consumer trends, competitor pricing, marketing budget, and inventory levels.

The disclosed invention provides integrated means and methods for registered and non-registered consumers to request and receive promotions and to trade promotional coupons and other promotional instruments.

The disclosed invention also provides means and methods for broadcasting promotions to mobile devices. The broadcasting may be localized and targeted to fit recorded consumer behavior, reported consumer preferences and the current marketing strategy of the enterprise.

These and other objects, features, and/or advantages may accrue from various aspects of embodiments of the present invention, as described in more detail below.

### BRIEF DESCRIPTION OF THE DRAWINGS

FIG. 1 is a block diagram of the distribution process.

FIG. 2 is a block diagram of the redemption process.

FIG. 3 is a block diagram of the settlement process.

### DETAILED DESCRIPTION OF CERTAIN EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

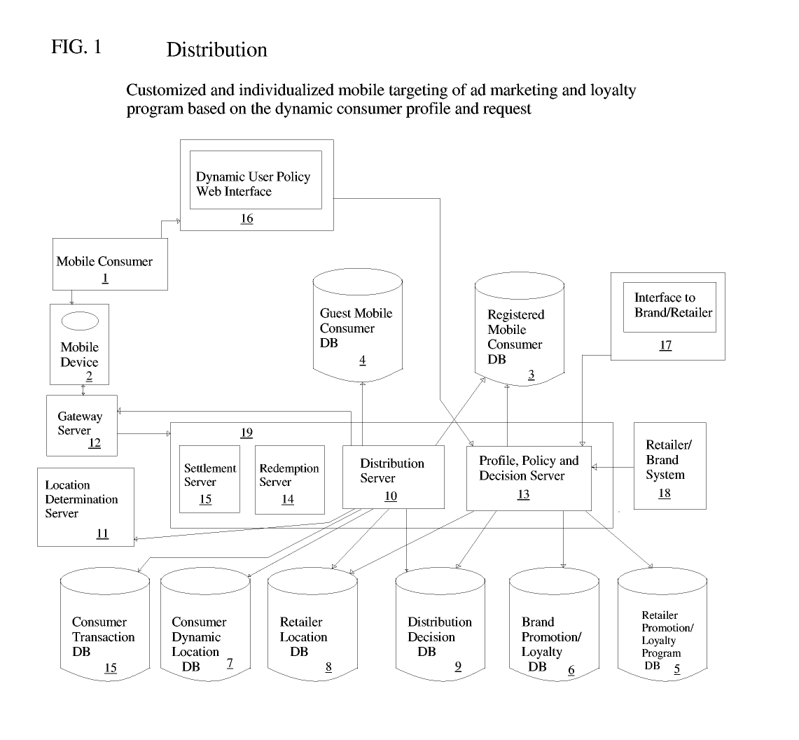

Distribution Components FIG. 1

FIG. 1 shows the distribution system and interaction with the server bank 19, distribution server 10, profile, policy and decision server 13 and the various data bases and other entitles as described and illustrated herein.

All servers within the server bank 19 have means to communicate with one another.

The distribution process may comprise a mobile consumer 1 who has a mobile device 2. The mobile device may comprise any type of wireless transmission technology, including, but not limited to, WiFi, 3G, 2G, 2.5G, 4G, WiMax, and Blue Tooth. The mobile device 2 may use any communication protocol, including, but not limited to SMS, MMS, WAP, and IMS.

A registered mobile consumer profile database 3 stores and records information, including but not limited to, personal, mobile ID, location, preferences, buying behavior, and purchase history of registered consumers.

A guest consumer profile database 4 stores information, including, but not limited to location, mobile ID, and buying behavior of unregistered consumers.

The retailer promotion/loyalty program database 5 stores and records information including but not limited to, enterprise information, discount types, reward types, dynamic discount policies, dynamic loyalty consumer purchase history, consumer demography, and consumer income profiles.

The brand promotional/loyalty database(s) 6 store and record information including but not limited to, brand information, discount types, reward types, reward types, dynamic discount policies, and dynamic loyalty policies.

The consumer dynamic location database 7 stores and records information, including but not limited to, consumer information based upon postal zip codes, mobile device identification, and GPS coordinates.

The retailer location database 8 stores and records the location of retailers.

The distribution decision database 9 stores and records information including but not limited to time, location loyalty, discount promotion type, discount percentage range, and consumer mobile identifiers.

The distribution server(s) 10 store and record data on a national, regional, and local basis.

The location determination server 11 may be used to ascertain the location of consumers using information, including but not limited to, GPS, mobile device identifiers, TOA, and STK.

Mobile gateway server(s) 12 may be located at service provider locations, such as an SMS center, MMS center, Wap gateway, or IMS gateway.

A consumer transaction database 15 stores and records consumer transactions.

The interface to brand/retailer 17 allows retailers and brand manufacturers the ability to access the disclosed system to change polices, create promotions and check ROI.

Distribution Processes and Interactions

1. The distribution server 10 interacts with the mobile server gateway 12 to ascertain the location of a consumer. The existence of the location based distribution server identity (e.g. short code) to the consumer may be discovered in one of the following ways:
a. Distribution server identity via SMS/MMS message to the consumer with the short code; and
b. Broadcast/multicast medium provided by the mobile service provider to the consumer.

2. Consumer interactions may occur with the policy server 13 to create or update a profile using one of the following mechanisms:
a. Mobile device 2 using SMS/MMS/IMS/WAP; and
b. Web interface 16 using HTML/XML or other means.

This process to advertise the identity of the Regional/Local Distribution server using the existing print based discount/ad/loyalty coupons provided the by the retailer/brand.

3. Consumer initiated interaction between a mobile consumer device 1, gateway 12 and distribution server 10 policy server 13 to request a promotion or coupon on a just in time basis.

4. Distribution server 10 interaction with the location determination server 11 in order to determine the location of the consumer.

5. Checking the existence of the consumer mobile ID in the registered mobile consumer profile database 3.

6. Checking the existence of the consumer mobile device ID in the guest mobile consumer profile database 4. If the consumer mobile ID does not exist then a new guest consumer entry is created.

7. Checking for the availability of a discount/promotion based on the pull request by the consumer by interacting with:
1. Retailer location database 8 to find the closest location to where the consumer desires the coupon/promotion;
2. Retailer loyalty/promotional program database 5; and
3. Brand promotion/loyalty database 6.

8. Updating the distribution decision database 9 by use of the policy server 13 if the requested promotion is available as described in part 7 above.

9. Continuously matching the preference and other criteria template including desired location in the registered mobile consumer database 3 with the loyalty/promotional program in the following databases:
1. Retailer location database 8 to match the location where the consumer desires the coupon/promotion;
2. Retailer promotional/loyalty program database 5;
3. Brand promotion/loyalty database 6.

10. Updating the distribution decision database 9 by use of the policy server 13 based upon the method of part 9 above.

11. Interaction between the enterprise/brand policy maker with the policy server 13 to update the promotional/discount programs using the interface to brand/retailer 17.

12. Interaction between enterprise/brand systems with the policy server 13 using XML/proprietary system-to-system interface or other means.

13. For a consumer request based upon the pull request as shown in part 7 above, the policy server 13 may respond back to the distribution server 10 regarding the distribution decision.

14. Continuously checking the Distribution Decision System and distributing coupons/promotional coupons on a enterprise push basis or a consumer pull basis:
1. Check based upon the event of part 13 above;
2. Check based on periodic polling event generated internally by the distribution server 10; and
3. Invoke message dispatcher to dispatch to the consumer mobile device 2 through the gateway server 12.

15. Creating transaction entries in the transaction database 15 for distribution made 12 above and uniquely identified by mobile ID, time, or coupon/promotional ID.

16. Updating mobile consumer buying profiles and preferences into the guest/registered mobile consumer databases(s).

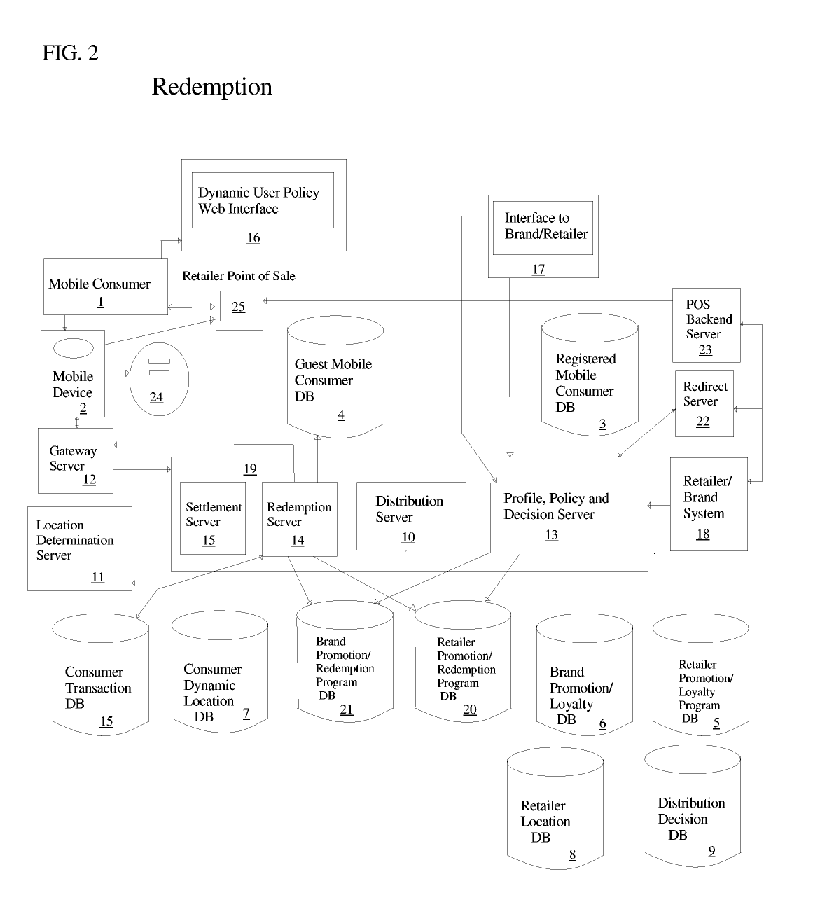

Redemption Components FIG. 2

The components of the redemption system that are not described above in the distribution section are shown in FIG. 2 and include: a retailer point of sale system 25, a point of sale (POS) backend server 23, a redirect server 22, scanable items 24, a brand promotion/redemption program database 21, redemption server 14 and a retailer promotion/redemption program database 20.

Redemption Processes and Interactions

1. When a mobile consumer 1, receives a coupon from the distribution server 10, the distribution server interacts with the location specific POS to perform the consumer transaction. During the process the consumer submits the coupon ID through one of the following means:
a. Show coupon; or
b. Provide the coupon information through a mobile device 2 using a wireless mechanism such as Blue Tooth, RFID, or other wireless mechanisms understood by the Point-of-sale or online system.

2. Retailer POS/Backend Authenticates by sending one or more of the following:
a. Coupon ID;
b. Mobile ID.

3. The POS back-end server 23 may send the coupon to the coupon redirect server 22 which performs mobile coupon processing. The coupon redirect server 22 is programmed to choose right coupon processing server based on the coupon coding mechanism.

4. The redemption server 14 receives the coupon processing request via XML or other defined interface between the redemption server and the corresponding Enterprise Retailer/Brand Server. After which, the redemption server does the following:
a. The redemption server queries the consumer transaction database 15 using the Coupon ID, and if found, checks to ensure that it is not being redeemed.
b. For a valid entry, the redemption server 14 optionally sends message to the mobile device 2 to ensure that the consumer is in-fact redeeming the coupon if the following steps mandate:
   i. if consumer policy dictates
   ii. If retailer/Brand Enterprise policy dictates
c. If part 4b above is performed, mobile device 2 upon receiving the request, responds as valid by replying back with Coupon ID. In addition, a user may ask for instant or instant redemption.

5. The redemption server replies as followings:
a. For successful, as in part 4 above, a reply is sent back to the Retailer POS via a Retailer Enterprise back-end server. Entries of the reply will include one or more the following:
   i. Accept the coupon;
   ii. If coupon doesn't have the face value it sends the redemption in terms of percentage of discount or the amount to be redeemed.

6. The redemption server 14 does following:
a. For promotions with instant redemption, the redemption server 14 marks the transaction entry as instant which will be used during payment stage for making the appropriate decision.
b. Marks the entry as in the redeemed state.

7. Upon receiving a successful authentication reply from the POS backend server 23 generates a transaction ID, transaction amount and other details.

8. A consumer obtains a transaction ID, transaction amount and other details from the retailer via one of the following means:
a. Manual means;
b. Mobile device using a wireless mechanism such as Blue Tooth, RFID, and other wireless mechanisms deployed between the Point-of-sale or online system and the consumer mobile device.

In addition, some of the optional steps maybe performed:
c. It maybe appreciated if the consumer scans item he purchased against which he intends to redeem the coupon using the barcode scanner/rfid reader integrated to the mobile device 2;
d. It also may be appreciated if the consumer scans the items of interest at any future time at retailer shop and/or home using the barcode scanner/rfid reader integrated to the wireless mobile device 2. This step may lead to entry of consumer data into one or more of the disclosed databases. This step can also be used independently if a consumer wants to order/re-order an item he can scan the item label.
e. A consumer my obtain the entire transaction receipt with items code and price via wireless mechanism into the wireless mobile device.

9. Interactions may occur between enterprise/brand Policy maker with the policy server to update the promotional/discount redemption program policy in the redemption program database.

10. Interactions may occur between Enterprise/Brand Systems with the policy server 13 using XML/proprietary system-to-system interface or other means.

11. Authenticating the redemption entries:

A process to check consumer transaction database entries and do the following:
a. Check to see if the transaction is the redemption stage;
b. Check to see if redemption has attainted its maturity;
c. Confirm the matured redemption entries with the retailer for its authenticity by one of the following ways:
   i. By requesting and receiving from the retailer relevant transaction information by any electronic communication means including but not limited to EDI or XML.
   ii. Through off line paper trails, tape systems, storage systems (magnetic/optical).

All matured and authenticated entries may then be sent to settlement phase and processed as described below.

### Alternative Embodiment of Redemption Process

1. An alternative embodiment of the disclosed redemption process includes step 1 and 8 from above and further steps as described herein. Step 1 from above is incorporated herein by reference as step 1.

2. Step 8 from above is incorporated herein as step 2 in this alternative embodiment.

3. Consumer interaction with the redemption server to redeem the coupon after purchase by providing transaction ID, transaction amount, and other items of information obtained using one or more steps a, b, c, d, e of step 2. One of the following mechanisms can be used to interact with the redemption server to send the mobile ID, coupon ID, transaction ID and other information:

a. Mobile device 2 using SMS/MMS/IMS/WAP;

b. Web Interface 16 using HTML/XML.

4. Process to check existence of the transaction entry in the transaction database using mobile ID and coupon ID. If it exists, update consumer transaction details with the information sent in step 2 and set the state to redemption state.

5. Interaction with retailer 20/brand redemption 21 database to obtain the redemption parameters including maturity time in number of days.

6. Interaction to update the mobile consumer database with the transaction details and consumer preferences of items which consumer might have obtained in the step 2 (c),(d), or (e). For example profile of brand/manufacturer items that the consumer is interested in. This information can be used to rank the brand/manufacture product usage and provide promotional recommendations to the retail/brand customers in the future. The process provides means of data mining.

7. Interaction with gateway server to send redemption accept message to the Mobile Device of the consumer in case of acceptance.

8. Interaction mechanism between Enterprise/Brand Policy maker with the policy server 13 to update the promotional/discount redemption program policy in the redemption program database.

9. Interaction mechanism between Enterprise/Brand Systems with the policy server 13 using XML/proprietary system-to-system interface or other means.

10. Step 11 from above is incorporated herein by reference.

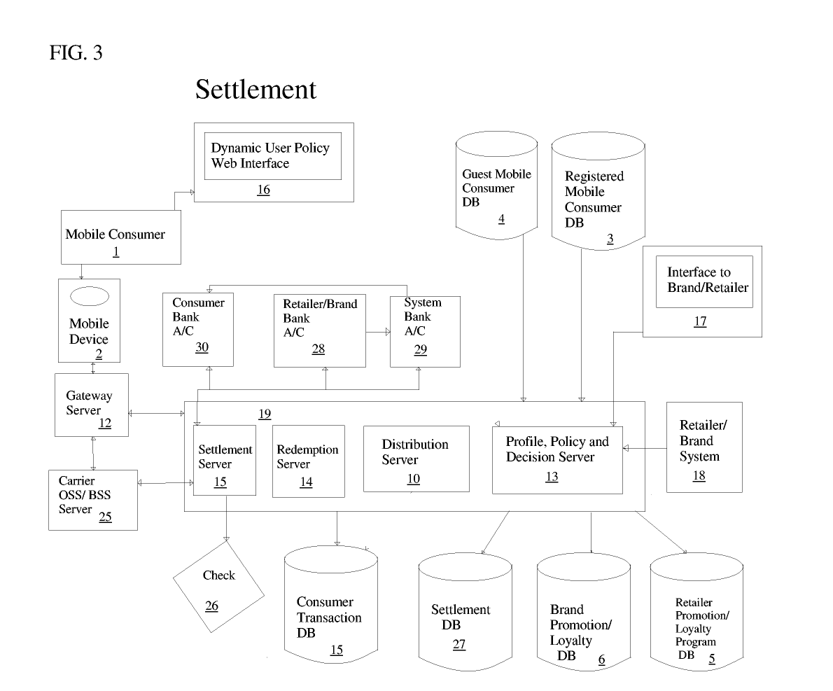

Settlement Components FIG. 3

The components used for the settlement process are shown in FIG. 3. and include, a carrier OSS/BSS(billing and settlement) server 25, a check 26, a settlement database 27, a consumer bank/financial institution 30, retailer/brand bank/financial institution 28, a system bank/financial institution 29 and a settlement server 15.

Settlement Processes and Interactions

1. For all transaction database entries that are in the settlement stage do the following for each retailer/brand, consumer ID:
a. Aggregate all the transactions
b. Create a list of transactions IDs and coupon ID
c. Calculate Total Amount of transaction performed
d. Calculate total Settlement amount by:
   i. Going through the list of transactions entries and coupon redemption value/percentage to calculate settlement value for each transaction;
   ii. Sum all per transaction settlement values to obtain total settlement value per retailer/brand, consumer ID;
e. Calculate total commission value by applying percentage and/or predefined value through policy agreed upon by the operators of the disclosed system and retailer/brand.

2. Step 1 from above will yield list for each brand/retailer to be settled with. Each entry will have following:
a. For retailer information such as store ID, for brand Information regarding the product;
b. Consumer ID;
c. List of transactions for the corresponding consumer including information such as transaction ID, coupon ID, amount, date/time and other collected information;
d. Settlement amount; and
f. Commission amount.

The information from the Step 2 list will be stored in the settlement database that can be accessed using brand ID, retailer ID or consumer ID.

3. Send the list generated from step 2 to the corresponding retailer or brand settlement System.

4. Settlement system at the retailer/brand end may perform the following:
a. Validate each of the entries sent by the disclosed system in terms of amount, coupon ID and other criteria;
b. Once validated issue the authorization of the payment for the transfer of the following amount to the system account, shown on FIG. 3 as no. 29:
   i. Consumer settlement amount;
   ii. System commission amount.

5. The disputed/invalidate entries of Step 4 may be communicated to the system and/or operators of the system. For each disputed amount corresponding to the consumer, transaction ID the disclosed system may mark the settlement database record with a key, consumer ID, transaction ID as disputed.

6. The settlement for the disclosed invention and commission amount received as a result step 4 may be transferred in one of the following ways:
a. Electronic transfer by retailer bank 28 to the system bank 29;
b. By check, 26;
c. Any other mechanism suitable for the operators of the disclosed invention.

7. Once the operator of the disclosed invention receives the settlement amount from the retailer/brand it shall go through the settlement database, for each consumer entry in the settlement database, it shall perform the following:
a. Aggregate all the non-disputed transaction entries to calculate the total amount due per consumer;
b. Issue the authorization to release the amount in one or more of the following ways using the consumer defined policies:
   i. Send electronic fund transfer authorization from the system bank 29 to the consumer bank account 30;
   ii. Issue a check to the consumer's address;
   iii. Based on the user policies, if needed, credit to the consumer's mobile account maintained at Carrier's end via OSS/BSS system 25:
      1. Provide mobile ID, aggregated txn amount, mobile account number to the carrier of the consumer (at the end of the period (typically a month);
      2. Authorize the amount transfer from system bank 29 to the carrier in the name of consumer mobile ID/account number with the carrier;
      3. Receive acknowledgement from the carrier.
c. Create a settlement ID per consumer settlement approved (settlement ID also tied to the disputed transactions).

8. Inform consumer via mobile device (SMS/MMS/IMS) or any other communication means (e.g. e-mail) that the consumer's promotional/settlement amount has been credited to the appropriate means, according to consumer's pre-defined/stated policies (e.g., email/SMS)
a. Settlement ID and the amount; and
b. Inform about disputed amount if any.

9. Finalize disputed amount with retailers/brands (depending upon the nature of dispute). Allow consumers to follow up using their settlement ID (either disputed items or transaction details). The retailer is kept informed as to the status of the settlement of the coupon.

10. On confirmation of the transaction closed (money leaving system bank 29, tag “close txn” on all successful transactions settled and do back-up of all closed txn.

Unless otherwise noted in this specification or in the claims, all of the terms used in the specification and the claims will have the meanings normally ascribed to these terms by workers in the art. Certain terms specifically comprise the meanings associated with them as follows:

Definition List 1

| Term | Definition |
|---|---|
| Promotion | The offering of sale incentives including, |
| | but not limited to, coupon, cash-back, |
| | discount, instant rebate, mail-in rebate, |
| | email rebate, online-rebate, voucher, |
| | sweepstakes, close-out sales, non-cash |
| | offers, and multiple products sold for |
| | the price of a lesser number of products. |
| Loyalty or reward | Units of value issued to consumers who |
| points | repeatedly purchase from the same |
| | seller or manufacturer. |
| Policy driven | The distribution of promotional material |
| promotion or | based upon criteria determined by the |
| enterprise push | enterprise entity. |
| Mobile device | And device capable of transport, |
| | including but not limited to a cellular |
| | phone, mobile phone, personal digital |
| | assistant (PDA), Treo, Blackberry, laptop |
| | computer, tablet personal computer, |
| | Palmtop, iPod, or multimedia device with |
| | wireless connectivity. |
| Enterprise entity | The organization issuing the promotion. |
| | Such an organization may be a retailer, |
| | manufacturer or seller of goods or |
| | services. |
| ROI | Return on investment |
| Consumer pull | The receipt of promotional material |
| | based upon consumer preferences |
| | and/or consumer requests. |
| Registered | A person who has previously caused |
| consumer | their identifying information to be |
| | entered into a database. |
| Guest consumer | A person who has yet to enter their |
| | identifying information into a database. |
| Embedded | A hyperlink, pop-up window, game clip, |
| marketing | streaming ad or multimedia ad that |
| promotion | contains or links to a marketing |
| | promotion. |

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A pay-per-transaction method of distributing promotions comprising the steps of:
(a) distributing personalized promotions based upon a consumer's preferences and/or an enterprise's promotional policy,
(b) tracking the distribution and receipt of promotions by means that allow for pay-per-transaction entries in a database,
(c) a consumer receiving a personalized promotion by electronic means.

2. The method of claim 1 wherein the consumer issues a request for redemption of the promotion.

3. The method of claim 2 wherein there is a validation of the consumer's request for redemption.

4. The method of claim 3 wherein there is a settlement of the consumer's validated request for redemption.

5. The method of claim 4 wherein the enterprise is charged for the transaction.

6. The method of claim 5 wherein the enterprise's return on investment is calculated.

7. A method of distributing marketing promotions to consumers comprising the steps of:
(a) receiving a request for promotions from a registered consumer though any mobile device;
(b) ascertaining the identity of the consumer by identification of the mobile device;
(c) ascertaining the current location of the mobile device;
(d) locating one or more promotions from the policy driven promotion database that best match the consumer's personal preference criteria; and
(e) sending promotions to the consumer.

8. The method of claim 7 wherein:
(a) the consumer's preferences for promotional criteria are stored in a database for future reference;
(b) sending a mobile communication message that contains a textual, graphical and/or a sound interface allowing the consumer to organize and view the promotion; and
(c) storing the promotional message and consumer response in a consumer database for monitoring the consumer's use of the promotion and tracking the consumer's actual behavior.

9. The method of claim 7 wherein the promotional message to the consumer includes a mobile gaming clip which delivers different promotional codes as a consumer reaches various winning levels in the mobile game.

10. The method of claim 7 wherein the promotional message includes a multimedia streaming ad.

11. The method of claim 7 wherein the promotional message to the consumer includes means that give the consumer the option of having the promotional code sent to an email address, phone number, mobile device, or other destination.

12. The method of claim 7 wherein a guest consumer sends a request for promotions.

13. A method of distributing localized and personalized promotions comprising the steps of:
(a) sending a request for the mobile identities that are in proximately to a location being promoted by the enterprise entity;
(b) receiving identification information about one or more consumers who are in proximity to a location being promoted by the enterprise entity; and
(c) sending mobile communication messages to the identified consumers that are personalized to each consumer and correspond to the promotion criteria established by the enterprise entity and/or the consumer's preferences.

14. The method of claim 13 wherein the promotional message to the consumer includes means that give the consumer the option of having the promotional code sent to an email address, phone number, mobile device, or other destination.

15. A method of exchanging promotions between consumers comprising the steps of:
(a) a consumer transmitting a request to trade promotional credit or promotional currency;
(b) an interested consumer responds to the request;
(c) the requesting and responding consumers negotiate an exchange; and
(d) the promotions are exchanged and the transaction is recorded in the promotion database and consumer database.

16. The method of claim 15 wherein an ongoing database of promotions available for exchange is maintained by means allowing consumers to upload their unwanted promotions.

17. The method of claim 15 including means to trade loyalty or reward points among consumers.

18. A method of redemption of promotions wherein promotions are redeemed and then recorded in a consumer transaction database, brand promotion redemption database, and retailer promotion redemption database.

19. A method of settlement of promotions comprising the steps of:
(1) the redemption server sends a request to the settlement server;
(2) the settlement server causes a check or other item of value to be issued the consumer;
(3) the settlement server updates the consumer transaction database, retailer profile database, brand profile database, and settlement database.

20. A method for distributing marketing promotions wherein:
(a) a consumer registers their promotional preferences;
(b) consumer(s) promotional preferences are matched continuously with the entries in the policy driven marketing promotions repository;
(c) promotions are selected from the policy driven promotions repository that best match a consumer's personal preferences;
(d) A mobile communication message is to the consumer's pre-registered mobile device by encapsulating the corresponding promotion identifiers along with other personalized information.

21. The method of claim 20 wherein one or more entries are created in the promotions distribution repository which may be used for tracking and future transaction fulfillment purposes.

22. A method of receiving and managing localized and personalized promotions wherein:
(a) The consumer mobile device receives one or more promotional messages containing promotion identifiers with personalized information; and
(b) The promotion message contains means to organize, browse, sort, present, view, or delete received promotional messages in the mobile device.

23. A method of distributing marketing promotions comprising the steps of:
(a) a consumer visits a Web page containing an advertisement:
(b) the consumer clicks on the advertisement or otherwise activates an embedded marketing promotion; and
(c) the consumer is prompted to enter information which would allow the embedded promotion to be directed within the consumer's device or to another device or location.
